(19) United States
(12) Patent Application Publication
(10) Pub. No.: US 2003/0083925 A1
(43) Pub. Date: May 1, 2003

(54) System and method for product category management analysis

(76) Inventors: Chana L. Weaver, Plymouth, MN (US); Linda J. Thompson, Plymouth, MN (US); Dion L. Kells, Norwood, MN (US); Kurt W. Nelson, Crystal, MN (US)

Correspondence Address: GENERAL MILLS, INC., P.O. BOX 1113, MINNEAPOLIS, MN, 55440, US

(21) Appl. No.: 10/002,566

(22) Filed: Nov. 1, 2001

(51) Int. Cl. G06F 17/60

(52) U.S. Cl. 705/10

(57) ABSTRACT

An automated system compiles and generates category management data and produces at least a partially customized reporting based on the data/input that is received from multiple internal and/or external sources to create a unique output for the intended end user. The illustrative system is able to blend the data associated with certain customer demographics and/or shopping patterns along with the data that is either provided from commercial databases or available from internal or proprietary data warehouses, to produce a targeted opportunity assessment and market analysis that can be pursued for growth. The automated system is also able to populate areas of the report with stable category data, where such information is not provided by or for the retailer. This auxiliary data is still current and relevant to the retailer and the particular market segment or category that the retailer is attempting to exploit. Automated analysis and local area network, intranet or Internet access can be employed.

### FIELD OF THE INVENTION

The invention relates to product data collection and analysis, and more particularly, to systems and methods for integrating a variety of data sources to provide product category management enabling retailers and others to make more informed decisions concerning the procurement, stocking, advertising and/or selling of various products.

### BACKGROUND AND SUMMARY OF THE INVENTION

When you go to the supermarket or other retail outlet, you expect to find the products you want to buy. If a certain desired product is not on the store shelves, the customer is usually disappointed. On the other hand, overstocking can be inefficient and costly to the retailer. For example, food products can spoil, some products can go out of demand due to seasonal or market changes, and excess inventory can tie up capital and requires storage space. This places a tremendous burden on retailers to keep their customers happy by stocking all the products the customers may want to buy but without significantly overstocking and continually turning over inventory.

An analysis known as product category management has been used in the past to help retailers solve such problems. Generally, product category management has endeavored to put the right amounts of the right products on the right shelves within a retail location at the right “everyday” price and promoted at the right time, price and type in order to maximize sales and efficiency. Historically, from the perspective of product distributors and manufacturers, product category management often involved getting as much of a particular product on the retailer's shelf as was physically possible. The general thinking of the manufacturer and associated distributor was that so long as more of one's product appeared on the shelf, then more sales of that product would naturally occur. Account representatives would often compete with one another to try and better position themselves within a particular account to gain more shelf space or shelf volume within each retail site. Additionally, the retailer was generally likely more inclined to stay with traditional products and brands that were known as good or stable selling products.

Sophisticated product management analysis has revealed that retailers staying with established stocks of products or manufacturers attempting to overload store shelves can actually lead to decreased product sales, diminished customer satisfaction and mundane appearance. This can result in declining revenue, profits and traffic for the retailer as well as decreased profits and sales for the manufacturers and distributors—sometimes straining the relationships between the retailer and manufacturer/distributor. Often, the retailer may not know or perhaps not realize that a combination of different products or even different product brands might yield better results, generate more sales and improve customer satisfaction with the retail establishment.

There have in the past been efforts to provide more sophisticated product management techniques to take such effects into account. Such analysis has proven to be very useful to the retailer. For example, a retailer sensing that he or she was missing an opportunity might, if appropriate, increase the amount of cereal or snack products on the shelves of the store and even possibly increase the total number of brands that are available. If a retailer senses that sales of a particular product category are ahead of the other market segments, he or she might choose to add additional product of that particular brand to his or her shelves.

However, there was a risk that increasing the total amount of product or types of a particular product (i.e. different sizes) might have the effect of actually diminishing the total available space for other products in the retail outlet. This situation could potentially have a significant adverse impact on the retailer. For example, customers might dislike the situation where many varieties of cereal or snack products line the aisles of retail grocery store shelves which can lead to inadequate choices for other types of foods. Most Americans generally want one-stop shopping, and will often begin using another retail outlet with more overall choice if they are disappointed more than a few times. Thus, effective category management was often found to require a more comprehensive solution, rather than this “hit or miss” type of approach which could fail to meet its intended target.

In particular, a general mix of products—including products that may be directly competitive to one another—can actually increase retailer consumer traffic and associated products sales and profits as well as assist in increasing sales of particular products for the manufacturer. Also, the ability to be able to adjust product volume on retailer shelves during cyclic periods can create additional benefits. For example, seasonally driven products can be given larger “shelf share” thus decreasing the carrying costs of inventory associated with seasonally slow products. In addition, product placement or product volume on the shelves can be tailored based on consumer traffic and the particular demographics associated with that traffic. For instance, where the traffic consists of shoppers 50 years of age or older, increasing health oriented products or categories will help drive sales. Where the consumer traffic comprises younger shoppers or shoppers with children, products having promotional offerings may be positioned on the lower shelves to catch the interest of children accompanying their parents in the store.

While retail mix analysis can thus be quite valuable, one of the problems with conducting such an analysis relates to the amount of data required from different sources. For example, it is possible to purchase or license useful data sets from a variety of sources including for example ACNielsen, Spectra Marketing, and others. Such databases like ACNielsen provides so-called consumer panel data that supplies consumer purchase information based on diaries and the like. ACNielsen also provides SCANTRACK and Market Dimension data sets that track consumer purchases in a given market through data collection based on in-store checkout scanners. Spectra Marketing provides demographic-based consumer information that can be used to develop sales and in-store marketing strategies. Some retailers also use planograms (i.e., graphical shelf space layout plans) to assist in retail product placement. All of these various data sources can be useful in product category analysis. Of course, for non-ACNielsen accounts different databases and data sources (e.g., internally developed data sources) could be used instead.

With all of these various types of data being available, one of the problems with prior solutions was generally the large amount of time required to collect and sort data relevant to a particular retailer's product mix or other objectives. More sophisticated analysis generally requires more data inputs (e.g., demographics, product purchase patterns, etc.). Therefore, such efforts in the past generally involved time-consuming collecting and sorting of static data available from various sources (e.g., store checkout scanners, product category information, demographics information, etc.). This data was then painstakingly analyzed to generate reports showing the retailer information such as the average retail price of the product and generally the rate of sales occurring in other areas which may be geographically related to the particular retailer.

The process of collecting, sorting and preparing the necessary data could often take anywhere from 40 to 200 hours. Because pulling data is so time-consuming, product category management analysts found they were spending most of their time just pulling data. Sometimes, this left insufficient time to analyze what the data meant, what action steps should be taken, and what areas required further analysis.

Additionally, the typically time-consuming data collection process would often tie up valuable marketing and sales resources. Sometimes, there would not be enough time to do the steps needed to create an appropriate report in time for a seasonal or promotional event in which a particular retail account may be interested in participating. It was sometimes even difficult to meet deadlines for a periodic account review—wasting opportunities and efforts.

In addition, it was generally not possible to quickly integrate additional data sources or information into data collection efforts to provide a more comprehensive analysis because to do so would increase the time required. Thus, such efforts could often fail to identify targets, market or segment gaps or goals that a retailer should strive to achieve (and which may not be readily apparent). The resulting reports sometimes provided only raw, fixed numbers relating to actual sales, but with no breakdown or other detailed analysis (e.g., through demographic modeling) of how those sales were achieved or what benefit or trend those sales illustrated. Such reports were of only limited usefulness.

A further complication is that many of the data sources are constantly being updated and changed. For example, data sources such as ACNielsen's, SCANTRACK data is updated monthly, Spectra Demograpic based consumer information is updated quarterly, Anilines every six months and on-going research updated periodically, and new data or category information is constantly being added from time to time to the particular database of interest. After such a monumental collecting and sorting effort, the ultimate report—even assuming it was available in time to be presented to the retailer—could easily be based on stale or out-of-date data or information.

Obtaining access to data sources can sometimes also be a limiting factor. Often, access to certain data sources is provided only in connection with a license or other fees and charges. This potentially excludes smaller retailers from the participating in such data gathering exercises, due to the expense of such license or other user fees or charges.

In addition, static data (such as that obtained from published sources) generally presented only a single dimension of a product category that may not be particularly relevant to the retailer. In fact, use of the data may further exacerbate the problem of diminished sales, depending on whether or not the particular retailer's problem are related to how the data was collected.

For these various reasons, further improvements are possible desirable and necessary. What is needed is a system that is easily accessible, user friendly and is able to compile and integrate multiple often dynamically changing data streams quickly. In more detail, it would be advantageous to provide a product category management and analysis system that improves productivity, allows integration of data from various sources, and allows tracking of retailer progress after objectives and action plans have been defined (i.e., “score carding”). Such a system should preferably be capable of generating a coherent, tangible format that is capable of identifying market opportunities or gaps in a particular retail sector. Such a system would enable the retailer to increase profits and the manufacturer product sales and distribution to other areas heretofore not contemplated by the retailer.

The preferred illustrative embodiment of the present invention solves these problems and adds additional capabilities, including but not limited to automated analysis and access to reporting functions via desktop, intranet, local area network (LAN) and/or Internet-based data automation functionality.

In more detail, a presently preferred illustrative system and method provided by the present invention relates to an automated system through which category data is complied and at least a partially customized report is generated based on the data/input that is received from multiple internal and/or external sources to create a unique output for the intended end user. The illustrative system is able to blend the data associated with certain customer demographics and/or shopping patterns along with the data that is either provided from commercial databases or available from internal or proprietary data warehouses, to produce a targeted opportunity assessment and market analysis that can be pursued for growth. The automated system of the preferred illustrative embodiment of the present invention is also able to populate areas of the report with stable category data, where such information is not provided by or for the retailer. This auxiliary data is still current and relevant to the retailer and the particular market segment or category that the retailer is attempting to exploit.

One aspect of the present invention provides an automated category management tool includes a database having a plurality of distinct data sets, at least one of said data sets containing pricing information on consumer products. A first input module capable of receiving data from at least one of said data sets from an end user of said tool, provides end user data to said database to create a comparative analysis for the end user. A first output module displays the analysis of the end user data in comparative association with at least one of the data sets. The comparative analysis creates a category management plan to increase product sales.

Another aspect provided by the invention provides a system for managing consumer product categories. A consumer product database provided at a first location contains variable retail data. At least one remote terminal is used for accessing the consumer product database. A central database has a pre-defined data set relating to certain consumer product categories. A communications arrangement connects the remote terminal to the consumer product database. The consumer product database provides category specific information to the remote terminal to create a marketing analysis for a retailer of products in the category.

### BRIEF DESCRIPTION OF THE DRAWINGS

These, as well as other objects and advantages of this invention, will be more completely understood and appreciated by referring to the following more detailed description of presently preferred exemplary embodiments of the invention in conjunction with the accompanying drawings, of which:

FIG. 1 depicts the system architecture in a presently preferred, non-limiting illustrative embodiment of an automated category management system;

FIG. 2 shows an illustrative category scorecard;

FIGS. 3 and 4 show illustrative computer display selection screens;

FIGS. 5-8 show illustrative flowcharts; and

FIGS. 9A-9F show illustrative output report segments.

### DETAILED DESCRIPTION OF THE PRESENTLY PREFERRED EXAMPLE EMBODIMENTS

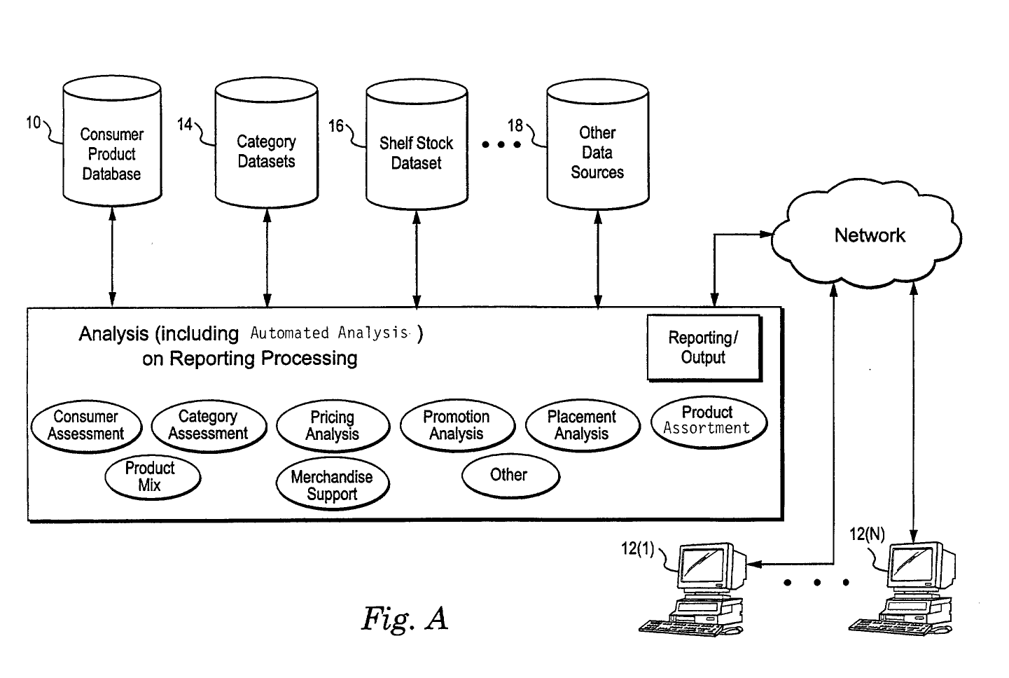

FIG. 1 is a schematic diagram of a presently preferred illustrative exemplary embodiment of a category management system 5 provided by the present invention. System 5 includes or has access (e.g., over a local intranet, LAN or the Internet) to a number of data sources, and provides analysis and reporting processing to generate reports for delivery in hard copy and/or display form. Such analysis and reporting can be very useful in providing consumer assessment, product category assessment, pricing analysis, product placement analysis, product assortment analysis, category scorecard/tracking analysis, and other useful outputs.

FIG. 1 shows a consumer product database 10 representing a collection of data providing information on consumer product purchases. Consumer product database 10 may, for example, comprises a Market Dimension, SCANTRAK or other database collected by commercially available sources such as ACNielsen that tracks consumer purchases in particular retail accounts and associated markets based on checkout line, cash register scanner data or purchases made via an on-line store over the Internet. Alternatively or in addition, consumer product database 10 may be derived from other sources (e.g., sources internal to the manufacturer, retailer or distributor) that have been specifically created for a particular category or market niche. Consumer product database 10 may also include consumer demographic information obtained for example from Spectra Marketing, a division of ACNielsen that collects information on households, geographic distribution, cosmetic make-up etc. In the case of commercial databases, user licenses or other access fees or charges may be required to utilize the data. The commercial databases are typically regularly updated (certain categories may be updated monthly, quarterly or yearly while others may be done on less than an annual basis) and expanded depending upon subscriber needs or market conditions, thus ensuring time-currency of the data.

In the illustrative embodiment shown, a second database 14 may provide information concerning different categories of products. In one specific illustrative and non-limiting example for use with grocery retail outlets, category database 14 provides seven different predefined product-based data sets: cereals, snacks, yogurt, popcorn, warehouse snacks, desserts and meals. Other example arrangements will provide other product and/or service categories (e.g., drug store retailers might require product categories based on products normally stocked by drug stores such as for example cold and flu medications, oral hygiene products, analgesic medications, etc.; camping equipment stores might require product categories particular to their trade, etc.)

Further data sets 16, 18, etc. may also be provided if desired. For example, a shelf stock dataset 16 (e.g., planograms) might provide information concerning the items actually stocked on the retailer's store shelves; product mix data may be imported from other applications; and consumer demographic information may also be imported. Other data sources 18 can provide any number of different types of additional information for further analysis.

In the example shown, an analysis and reporting processing block 20 is coupled to the data sets 10, 14, 16, 18. The analysis and reporting block 20 performs analysis on the various data sets, and generates associated reports as requested or required by an end user. End users communicate with the analysis and reporting processing block 20 via remote data terminals 12(1), . . . , 12(N). In one example embodiment, the analysis and reporting processing block 20 is performed by software running on the remote terminals 12, and the remote terminal or input module 12 is able to access the commercial database 10 and other data sets 14, 16, 18 over communication means 13, such as telephone lines, high speed ISDN lines, cable connections, a network such as a local area network, wide area network, the Internet, or any other technique for allowing data to be communicated from one point to another. In one example embodiment, the various data sets 10, 14, 16, 18 may be located in disparate geographical locations remote to one another and to analysis and reporting processing block 20, and the analysis and reporting processing block reaches out over telecommunications infrastructure to access these data sets.

In another example illustrative and non-limiting embodiment, the analysis and reporting processing 20 is performed on a server that accesses the various data sets 10, 14, 16, 18 via any convenient type of communications arrangement (e.g., the Internet or other network (LAN), dedicated or dial-up telephone lines, delivery of mass storage media, etc.), and the data terminals 12 access the server via the Internet, LAN or other network 13. For example, server 20 may comprise a web server, and terminals 12 may comprise web browsing appliances such as personal computers, set top boxes, or any other appliance with a display and a user input device that is capable of displaying and interacting with web pages. Other example arrangements use data protocols other than Internet protocols, such as protocols for a local area network or wide area network to provide communications between analysis and reporting processing block 20 and data sets 10, 14, 16, 18 and/or data terminals 12.

The preferred exemplary non-limiting but illustrative analysis and reporting processing block 20 includes a number of modules or cells that are used independently and together to process and analyze the data provided by consumer product database 10, category database 14, shelf stock data set 16 and/or other data sources 18. In the example embodiment, such functional processing modules or other routines may include:

Consumer Assessment module 102,

Category Assessment 104,

Pricing Analysis 106,

Promotion Analysis 108,

Placement Analysis 110,

Product Assortment analysis 112,

Product Mix analysis 114,

Merchandise Support analysis 116, and

possibly additional analysis 118 (depending on the desired output).

In the exemplary illustrative embodiment, each cell or module (routine) produces a portion of a report output that may have separate sections or fields that can display both variable and non-variable data that is product, category or retailer specific. In the event that data specific to the customer is added to the system, the module or cell is capable of converting relevant data collected from the databases 10 and/or 14 (and other databases 16, 18) and extrapolating the relevant portions to create a retailer specific report for that module or cell. If no data relevant to the retailer is provided, then the module or cell in the illustrative embodiment goes to a default mode, collecting data from database 14 to populate that portion of the module or cell. Thus, system 5 can provide reports that have more or less detail depending upon the amount of information that is available.

For example, in one exemplary embodiment, certain reporting performed by analysis and reporting processing block 20 may rely on pre-run analysis performed by other applications. For example, in the illustrative embodiment, planogram (i.e., graphical shelf space layout) analysis is optional; if the analysis has been done by a conventional off-the-shelf planogram analysis package, then preferred illustrative embodiment analysis and reporting processing block 20 can take the results into account in its own analysis and/or report generation. Generally, planogram data is collected by shelf management specialists who work with the retailer to determine what constitutes or defines a shelf or product stocking areas, and which SKU's should appear on which shelves. In essence, the shelf management specialists develop a “picture” or composite of the shelf in the particular retail store or retail area. This allows the retailer to track movement of products from the shelf (product volume) and determine profit/loss margins of the product and the category. As discussed above, the analysis and reporting block 20 can use planogram data to good advantage if such data is available from data set 16, but can proceed to generate highly useful reports even if such data is not available. On the other hand, if no planogram information or analysis is available, then analysis and reporting processing block 20 can proceed without it to generate a category management report that may not have all of the information as one which takes planogram information into account but which nevertheless provides very useful information.

If the default mode is chosen in the illustrative embodiment, the data is still relevant to the category or product so that the analysis can continue in identifying possible market gaps or opportunities for the particular retailer. For instance, the default data may be total product or category sales in the United States or regional sales such as sales in the Midwest. Other default data can be retrieved from previously created retailer profiles that have simply not been updated since the last time the category management program was demonstrated to the account. The preferred illustrative embodiment thus has the ability to dynamically adapt to a variable number of different data input sources that may be present, include the additional associated analysis in generated reports if present, and provide standard or “default” (i.e., static) information if the associated data/analysis is not available. In this way, users of system 5 can automatically generate more or less detailed and analysis-intensive reports depending on customer requirements.

Referring still to FIG. 1, in the example embodiment, the Consumer Assessment module 102 assists in making a determination of how the consumer traffic in the particular environment being studied align with other competitive stores as well as measures the traffic in connection with the particular demographic to which the product category is targeted. The Consumer Assessment module 102 can, for example, report the amount of household penetration, the purchase cycle, the amount of money spent per visit and the number of units per trip and per buyer.

In the illustrative embodiment, the Category Assessment module 104 calculates the share of product being sold by the retailer as opposed to competitive retailers or some other component by which the retailer is being measured.

In the illustrative embodiment, the Pricing Analysis module 106 is able to provide the retailer with a comparison between the retailer's “everyday price” and promoted prices under varied merchandising conditions and those prices that are published by other retailers in newspapers or other advertisements. The retailer can then identify the possible success that a price reduction may have in connection with a product or category promotion against the price being charged in the store on a regular basis.

In the example embodiment presented herein, the Promotion Analysis module 108 measures the effect that incentive based marketing or promotions may have on a particular retail account. For instance, a retail location that has significant family traffic may receive a larger benefit from promotional offerings on “kid” brands or larger sizes than those store locations with a more mature traffic.

In the example embodiment presented herein, the Placement analysis 110 Assortment module spotlights locations on the shelf or store where a product may be better showcased or displayed. In addition, the placement analysis module 110 can suggest the amount of space a product should be given on a shelf in order to realize the benefit of any gap that has been identified by the system.

In the example embodiment presented herein, the product assortment module 112 identifies the problem on the shelf, such as whether there is enough product on the shelf in order to meet the projected demands of the consumer traffic that is expected to be visiting the store, or making the shelf more efficient, such as by putting products oriented or marketed at children on the lower shelve, or putting in gravity fed product dispensers so that when product volume on the shelf falls, the last few products remaining are not difficult to reach as the product is pushed forward by the dispenser.

In the illustrative embodiment, a module 114 directed to Product Mix is included in the present system and is used to suggest additions or deletions of products, change the product mix on the shelf, or even change the size of the same product being offered, i.e. from a 14 ounce box of cereal to a 20 ounce box.

In the illustrative embodiment, the Merchandising Support module 116 indicates the success of promotions that have been offered in order to assist a retailer in identifying an opportunity or gap that could be pursued. In addition, the type of promotion can be tailored to the type of customer traffic that the store receives.

Other modules 118 can perform additional processing as required by the demands of the account or inquiries of the client.

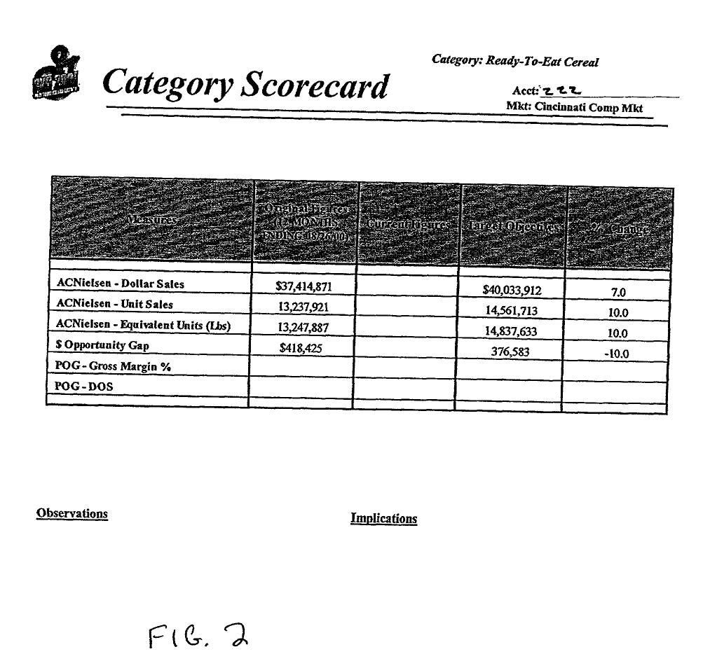

In the example embodiment, a reporting/output block 114 generates reports including various types of information. Such reports can be in hard copy form; and/or they can be interactive electronic documents such as web pages, spread sheets, PowerPoint® presentations or the like; and/or they can comprise electronic data files for further review, display, and processing by additional applications. An example report is attached to the end of this specification. In the example embodiment, as part of the reporting operations, the reporting/output block 114 creates a Category Scorecard, which summarizes the possible opportunity, or gap that the retailer can pursue by making the changes in product or category suggested by the system and currently being stocked on the shelves of the retail outlet. The Category Scorecard can also be used for internal tracking by region for product distribution. In addition, the Category Scorecard provides a performance read which shows where the retailer scores relative to the national or regional performance levels of the same product grouping. See FIG. 2 for an example of an illustrative Category Scorecard. Such a category scorecard is useful for allowing a retailer to understand the current category management situation and also to determine how the situation has improved some time after changes have been implemented.

Additionally, the analysis and reporting processing block 20 in the illustrative embodiment uses automated analysis to generate “Observations” and “Implications” of the data that is collected and provides a summary of the particular data field being displayed. In the Consumer Assessment module 102 for example, the Observation portion may detail the demographic information of the consumer traffic that a store or chain of stores regularly receives, i.e. families with children, affluent suburban shoppers, etc. Through use of the data, it can be determined whether there is a logical fit between the product in the particular category being analyzed, i.e. ready to eat (RTE) cereals, and the particular segment of the population that is visiting the store. For example, typically families with children are the type of demographic a particular retail outlet needs to have in order to concentrate on RTE cereals. An older demographic might concentrate on foods having a health benefit such as cholesterol reducing foods. Based on this data analysis, the retailer can then modify the mix of products in the store or adjust the various shelf allocations being given to the products currently on display.

In the Category Assessment module 104, the data may help the retailer determine whether a particular category is overdeveloped, that is, the retailer is experiencing better than average sales. In this particular instance, the illustrative embodiment can be used for example to target a subsection of a category where additional sales might be obtained while at the same time retaining better than average sales of the remaining products in the category. For example, the illustrative embodiment might be used to help identify that RTE cereals being sold to families with children is not meeting a predefined target or average and as such the retailer could add more products that are directed to children.

The output generated by exemplary system 5 is preferably formatted to fit within a series of predetermined screens, templates or settings. For instance, the display can be set up so that the output is displayed with the logo of the manufacturer who is making the presentation, with the logo and colors of the retailer or in some neutral arrangement. The output may be presented in a PowerPoint® or Excel® program to facilitate the presentation of the material. The user of the system can change the order of the modules or cells for any particular presentation or remove certain modules or cells that are not deemed necessary.

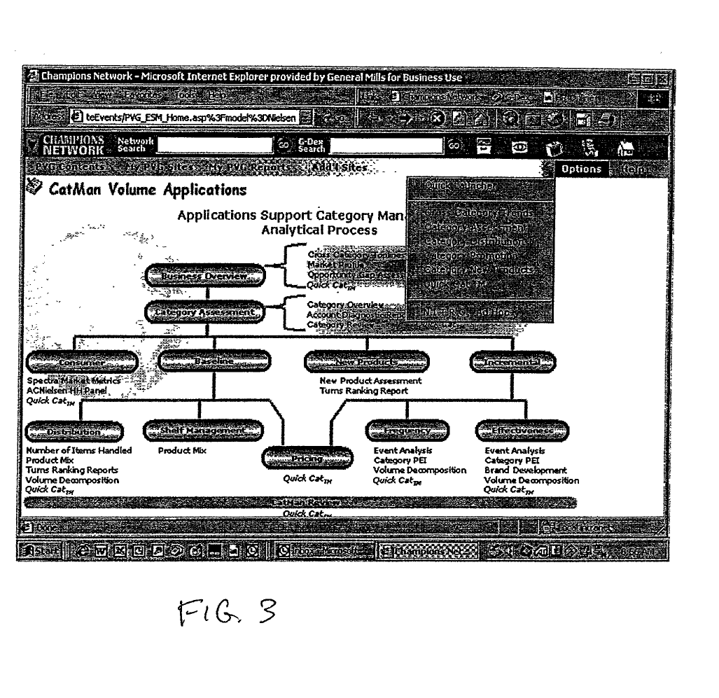

FIG. 3 shows an example browser view that may be generated on terminals 12 to access system 5 on a desktop and/or over a network. As can be seen, a “click-on” menu of a comprehensive set of various tool options (e.g., business overview, category assessment, consumer information, baseline information, new product information, incremental analysis, distribution analysis, shelf management analysis, pricing analysis, frequency analysis, and effectiveness analysis) can be used to launch the functionality of system 5 shown in FIG. 1. In this particular illustrative embodiment, the phrase “Quick Cat™” refers generally to functionality provided by illustrative system 5 shown in FIG. 1.

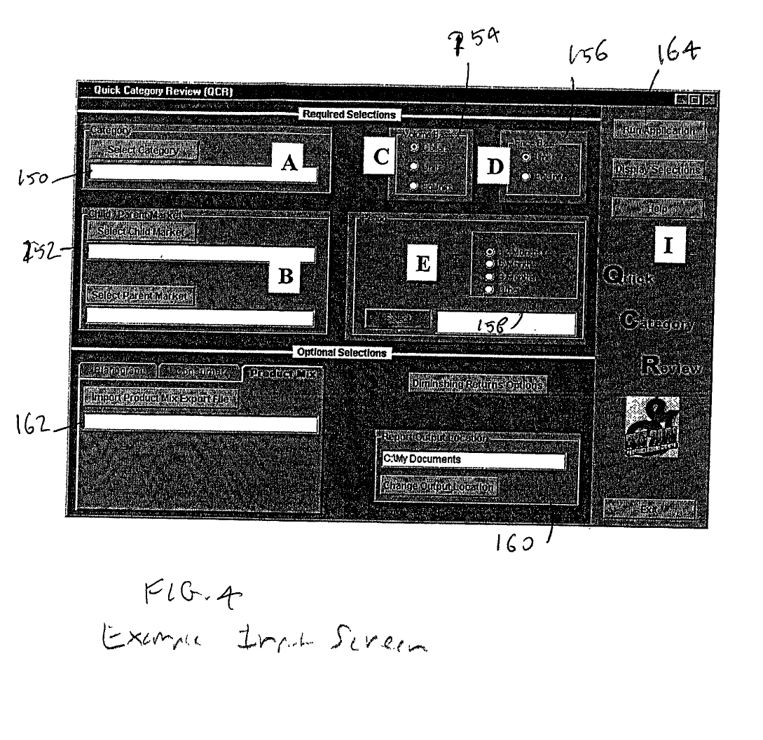

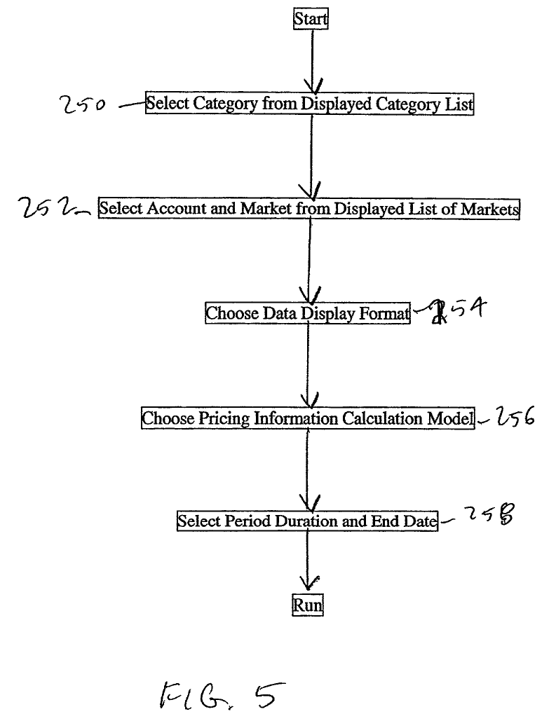

FIG. 4 shows an example input screen that may be used to select different reporting options, and FIG. 5 shows an example flowchart that a user may follow to select such options. In the example shown, the user may first select a category (FIG. 4 field 150; FIG. 5 block 250) from a list of displayed product categories (see discussion above). The user may next select account and market information (FIG. 4 field 152; FIG. 5 block 252) from, for example, the ACNeilsen Market Dimension database that may be part of data set 10 (in the example illustrative but non-limiting embodiment, dry grocery and dairy shares will be automatically populated if available, but other implementations with other requirements will use different categories).

The example embodiment further allows the user to specify how he or she would like the data displayed (e.g., $ volume, units or EQUnits) (FIG. 4 field 154; FIG. 5 block 254). The user may also be given the opportunity to specify how pricing information is to be calculated (e.g., units or EQUnits) (FIG. 4 field 156; FIG. 5 block 256). The example embodiment then allows the user to select the number of months and period ending data for the analysis (FIG. 4 field 158; FIG. 5 block 258). As shown in FIG. 4, additional options include specification of a destination for the output report (FIG. 4 block 160), and a capability to import optional data input sources such as for example product mix export file, planograms and consumer data (FIG. 4 block 162). Once the user has made the desired selections, the user selects the “run application” button (FIG. 4 block 164) and processing block 20 performs the appropriate analysis and generates the desired output report(s).

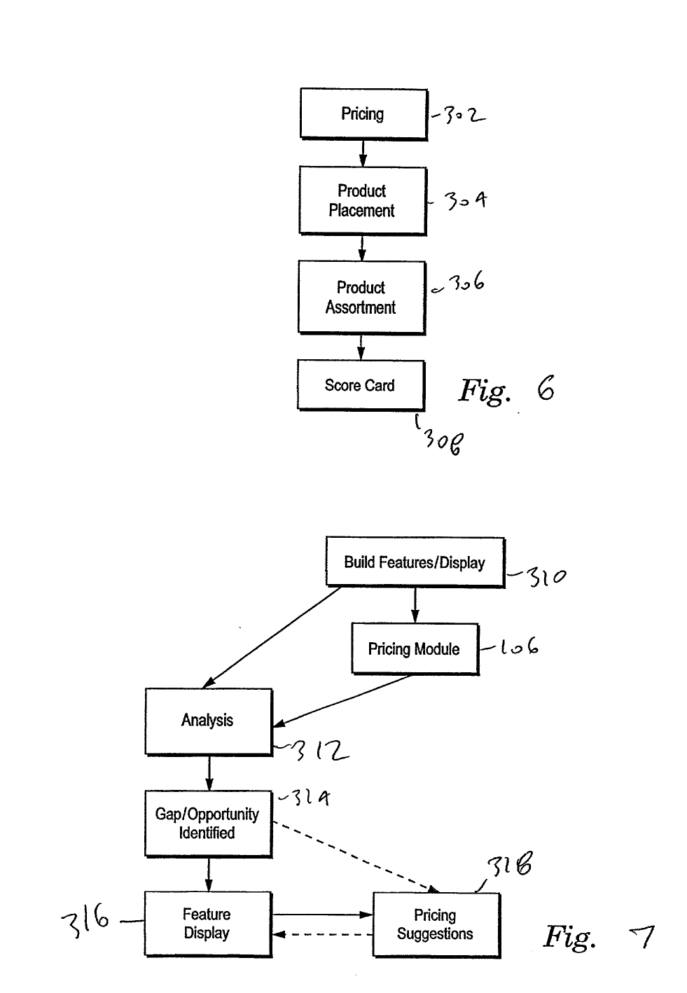

FIGS. 6-8 are flowcharts of exemplary analysis steps performed by illustrative system 5. In the example embodiment shown in FIG. 6, processing performed by block 20 can comprise:

pricing processing 302,

product placement processing 304,

product assortment processing 306, and

score card processing 308.

In the example shown in FIG. 7, category management analysis processing can be performed by using a build features/display (block 310) and pricing analysis module 106 to perform an analysis 312 to identify a gap or opportunity (e.g., a particular product or class of products isn't selling as well at the retailer as the various geographical, demographic and other data would indicate it should be) (block 314). In the event that such a gap or opportunity is identified, the preferred example embodiment may generate a feature display (block 316) and provide appropriate pricing (or other) suggestions (block 318) that may improve the sales of that product or category of products. The process shown in FIG. 7 can be iterated to provide farther refined results based on different scenarios created by the end user interacting with the generated report.

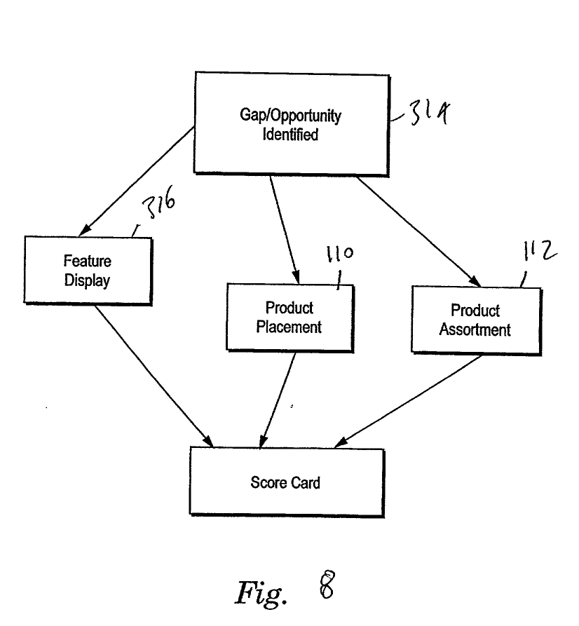

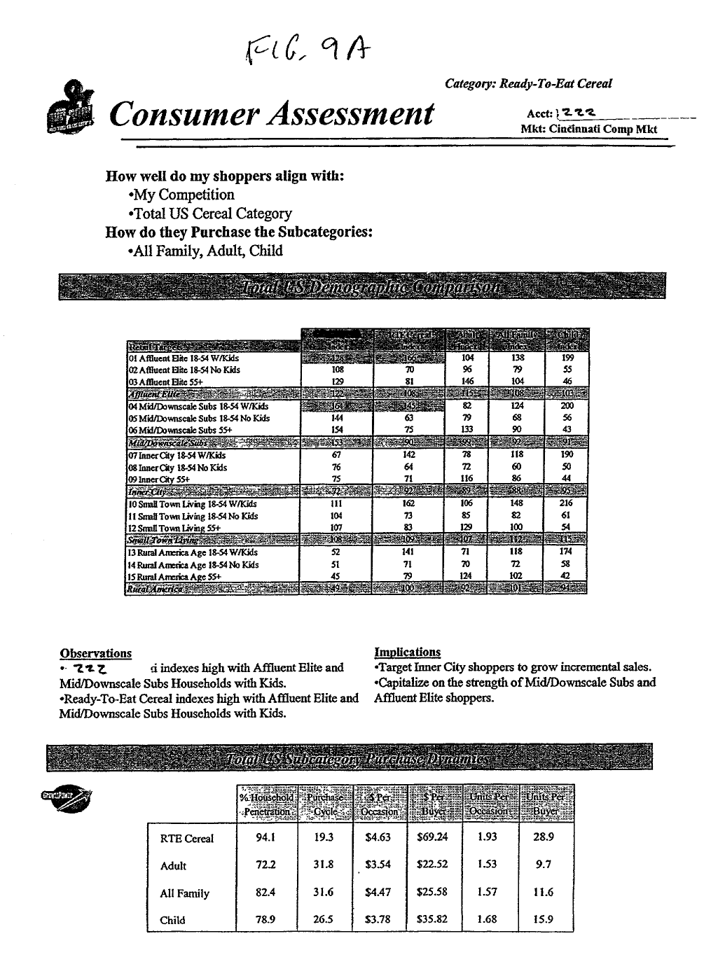

FIG. 8 shows how identified gaps/opportunities (block 314) and feature display (block 316) may be used with product placement analysis 110 and product assortment analysis 112 to develop a score card as shown in FIG. 2.

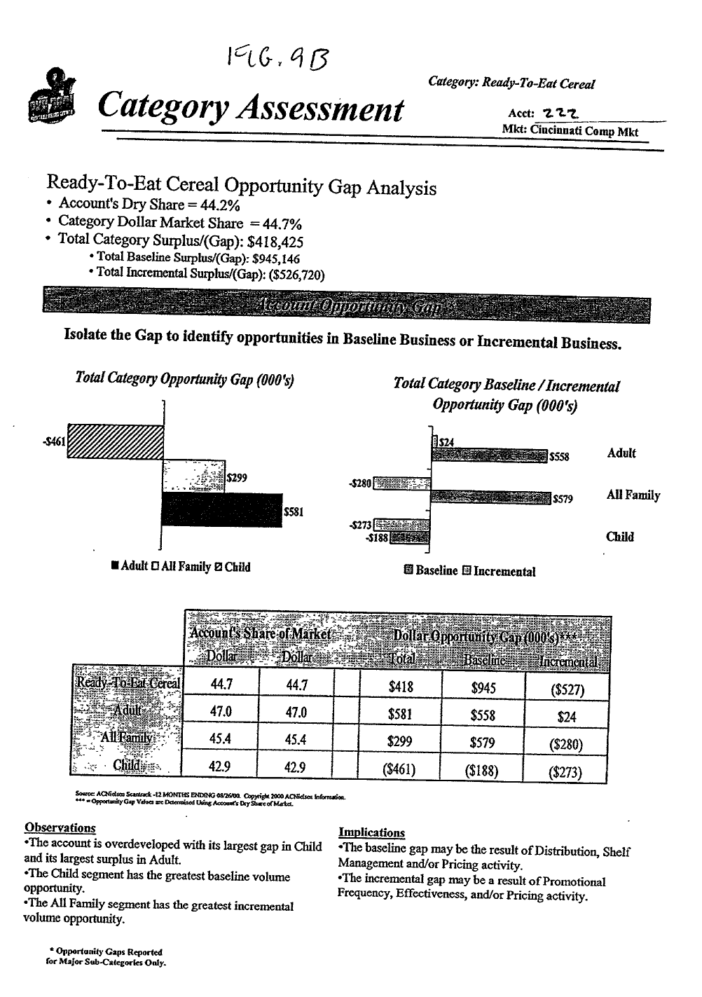

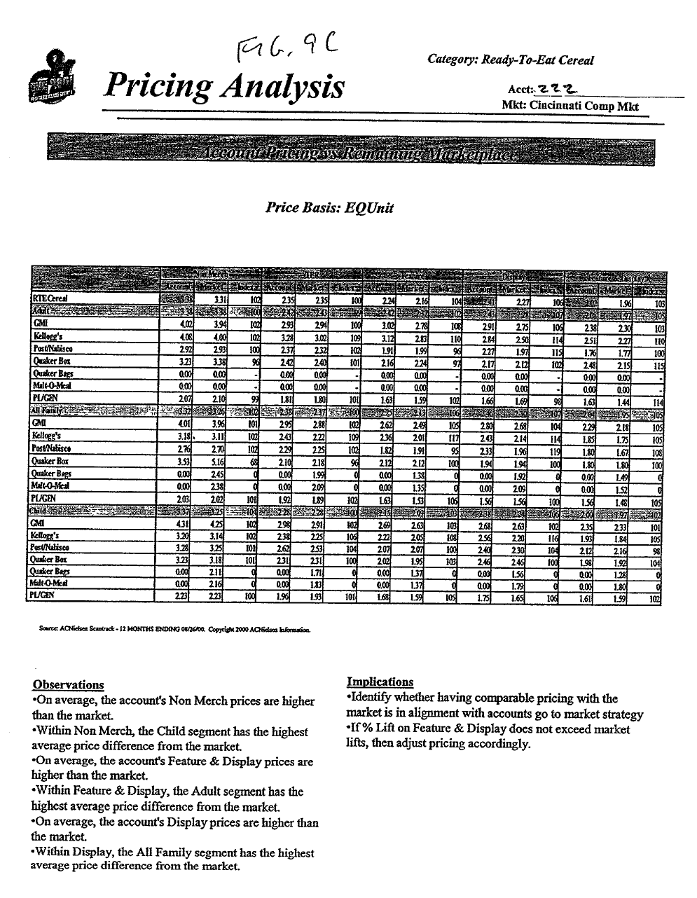

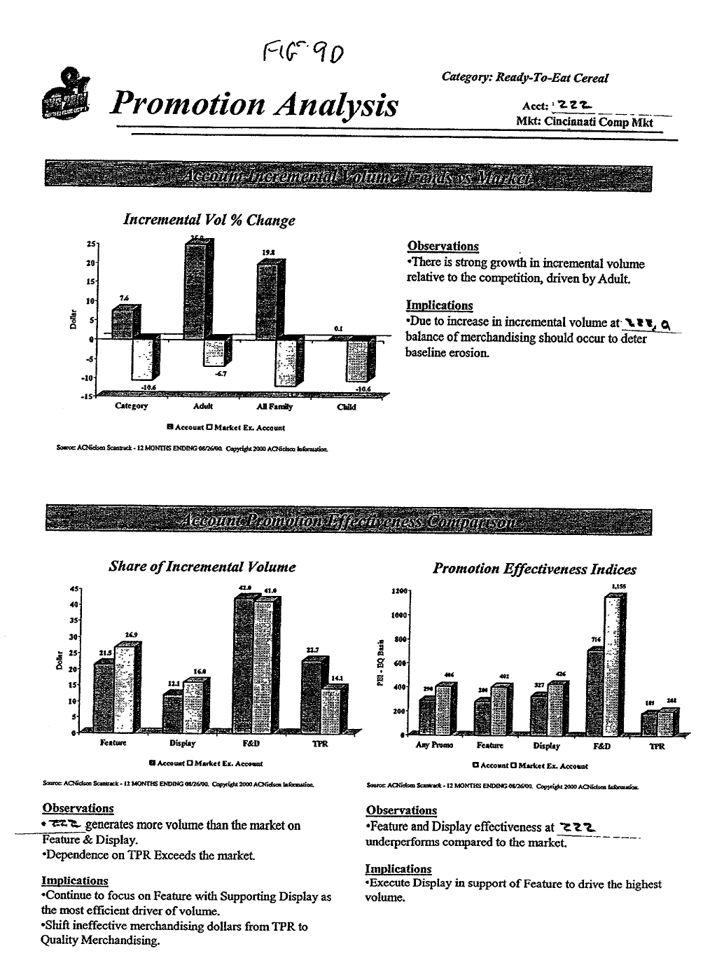

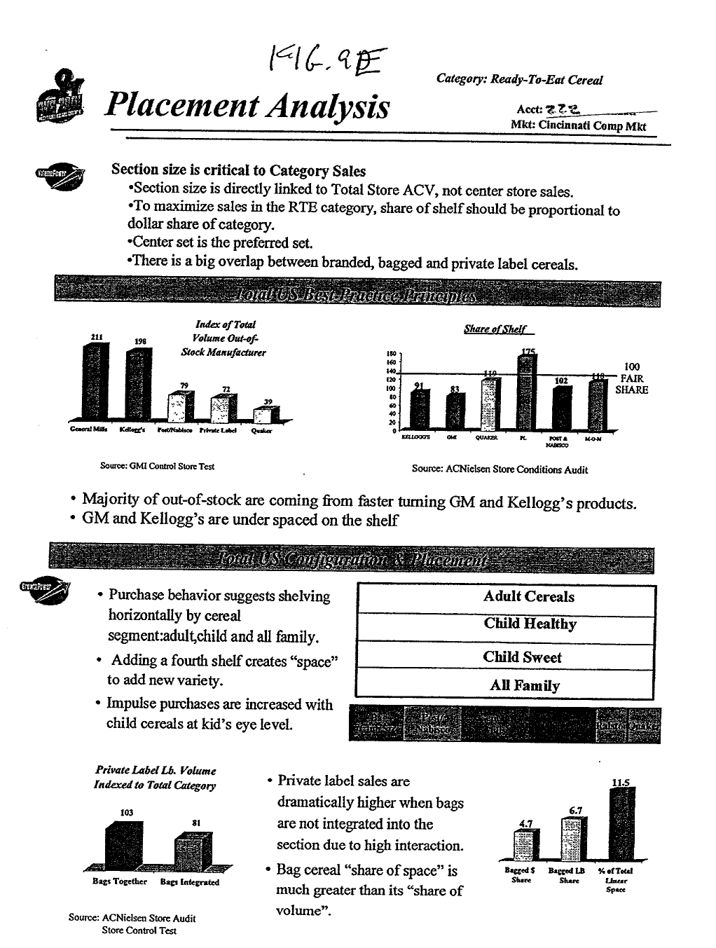

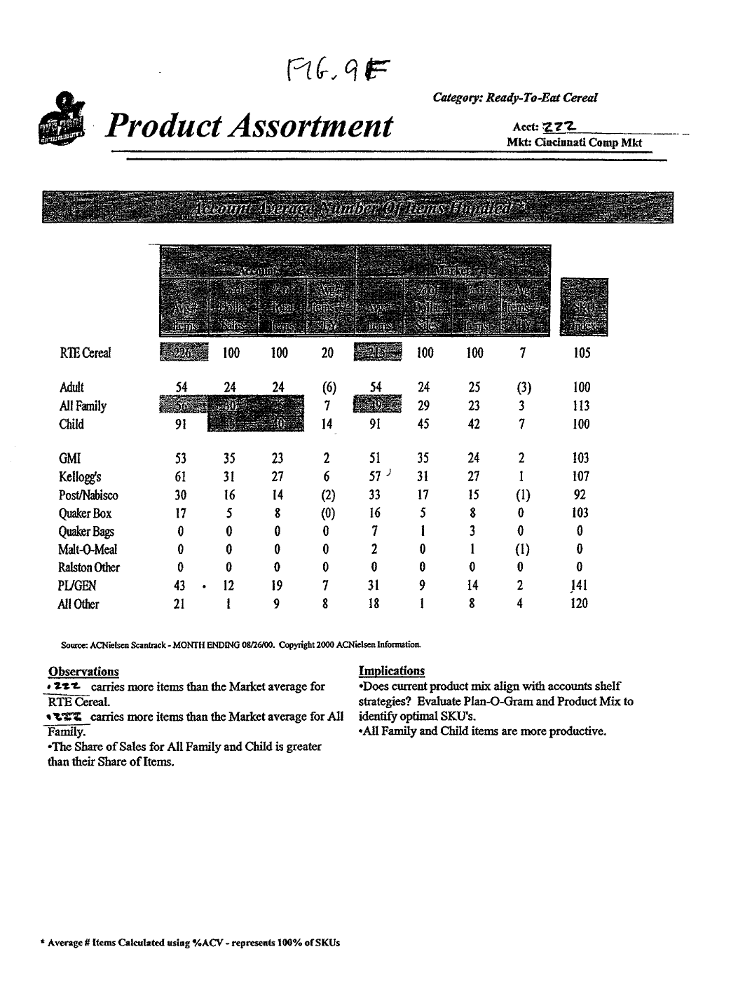

FIGS. 9A-9F show exemplary illustrative report segments for:

consumer assessment (FIG. 9A);

category assessment (FIG. 9B);

pricing analysis (FIG. 9C);

promotion analysis (FIG. 9D)

placement analysis (FIG. 9E);

product assortment analysis (FIG. 9F).

As discussed above, in some cases these illustrative displays/outputs include fixed or static data in some areas based on more limited analysis due to unavailability of certain data. Additionally, these display formats in the preferred illustrative embodiment are interactive in the sense that a user can “click” on or otherwise select portions thereof and additional detail can be displayed in response to provide a targeted tactical drilldown. If desired, the reporting could be expanded for example to provide an executive summary of all priority categories.

The information of the type shown in FIGS. 9A-9F may be provided in the form of interactive displays such as PowerPoint® or web page displays. In addition, system 5 may provide further detailed information in the form of electronic data files for printout and/or further analysis. Such data files could include for example:

detailed sales review on a product-by-product basis including for example total volume sold in US, retailer's market share, rest of market, etc.

detailed pricing analysis on a product-by-product basis broken down by the categories “non merch”, “TPR”, “Feature” and “Feature and display” and further broken down in each by “account”, “market” and “index”;

a category management schematic overview (e.g., category sales amount, share of category sales in percentage, share of category profit, share of category unit movement, percentage of linear shelf space taken up by category, average shelf DOS, and Average Shelf return on investment);

best and worst weeks promotional review on a per category basis;

segment fragmentation analysis for each category;

account shopper profile information;

competitive and consumption indices;

demographic profiles;

diminishing returns ARC;

demand index;

product mix optimization summary; and

product mix add and delete summaries.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

While the present invention as described herein, including the exemplary embodiments are directed to categories primarily related to food or products found within a grocery store or warehouse club, it should be understood, that the present invention is applicable to a wide array of products such as personal care products; general merchandise such as toys, seasonal goods, sporting goods, apparel and footwear; specialty items such as hardware, arts and craft supplies; stationery and office supplies; pharmaceutical and healthcare products; horticultural and gardening supplies; alcoholic, carbonated and non-carbonated beverages; automotive products and accessories; furniture and house wares; and other consumer related products. Thus, while the invention has been described in connection with what is presently considered to be the most practical and preferred embodiment, it is to be understood that the invention is not to be limited to the disclosed embodiment, but on the contrary, is intended to cover various modifications and equivalent arrangements included within the scope of the appended claims.

What is claimed is:

1. An automated category management tool comprising;
a database having a plurality of distinct data sets at least one of said data sets containing pricing information on consumer products;
a first input module capable of receiving data from at least one of said data sets from a user of said tool, said input module providing end user data to said database to create a comparative analysis for said end user;
a first output module for displaying said analysis of said end user data in comparative association with at least one of said data sets; and
wherein said comparative analysis creates a category management plan to increase product sales.

2. An automated category management tool as recited in claim 1 wherein said at least one of said data sets relates to cereal.

3. A system for managing consumer product categories, comprising;
a consumer product database provided at a first location and containing variable retail data for at least one consumer category;
at least one remote terminal for accessing said consumer product database;
a central database having a pre-defined data set relating to sadi at least one consumer product category;
a communication arrangement connecting said at least one remote terminal to said consumer product database; and
wherein said consumer product database provides category specific information to said remote terminal to create a marketing analysis for a retailer of products in said at least one category.

4. A system for managing consumer product categories as recited in claim 3, wherein said at least one consumer product category is cereal.

5. A category management method comprising:
obtaining data from plural data sources including a consumer purchase tracking data set and a demographics data set;
analyzing said data sources to provide an integrated category management report; and
dynamically including or excluding further detailed information from said report depending on whether additional analysis results are available.

6. A category management method comprising:
obtaining data from plural data sources including a consumer purchase tracking data set and a demographics data set;
using automated analysis to analyze said data sources; and
providing an integrated category management report based at least in part on said analysis.

7. A category management method comprising:
obtaining data from plural data sources including at least a consumer purchase tracking data set, a demographics data set and at least one planogram;
analyzing said data sources;
providing an integrated category management report based at least in part on said analysis; and
delivering said report at least in part over a network.

8. The method of claim 7 wherein said report includes interactive fields that can call up additional information.

9. The method of claim 7 further including using automated analysis to analyze said data sources.

10. The method of claim 7 further including dynamically including or excluding further detailed information from said report depending on whether additional analysis results are available.

11. The method of claim 7 further including providing a score card that tracks said category management over time.

12. The method of claim 7 wherein said network is the Internet.

13. The method of claim 7 wherein said network is a local area network.

14. A method of tracking category management over time comprising:
using plural data sources to develop category management summary information;
displaying said summary information in a score card format;
at a later time, using updated data sources to develop updated category management summary information; and
displaying said updated information in said score card to show whether there has been improvement.
